(19) United States
(12) Patent Application Publication
(10) Pub. No.: US 2013/0030646 A1
(43) Pub. Date: Jan. 31, 2013

(54) INTERACTIVE VEHICLE HELP MENU

(71) Applicant: Nathaniel Ellis, Marysville, OH (US)

(72) Inventor: Nathaniel Ellis, Marysville, OH (US)

(73) Assignee: Honda Motor Co., Ltd.

(21) Appl. No.: 13/192,979

(22) Filed: Jul. 28, 2011

(51) Int. Cl. G06F 17/00

(52) U.S. Cl. 701/36; 701/1

(57) ABSTRACT

A system provides a user of a vehicle with interactive vehicle help. The system includes a first user input device that allows the user to enable an interactive vehicle HELP mode, and a second user input device that allows the user to selectively trigger execution of a vehicle function. The system further includes an output device and at least one processor. The processor is programmed to receive the user request that enables the interactive vehicle help mode; disable execution of the vehicle function in response to the received user request; and output help information pertaining to the vehicle function to the user via the output device in response to triggering of the user input device. Additionally, if in the HELP mode, an override feature may be provided to allow the user to enable the execution of the vehicle function in response to an override user request.

### BACKGROUND

The present exemplary embodiment relates generally to information and control systems. It finds particular application in conjunction with providing drivers with electronic help information in an intuitive manner, and will be described with particular reference thereto. However, it is to be appreciated that the present exemplary embodiment is also amenable to other like applications.

Vehicles traditionally include operation and/or help documentation, such as instructions on changing a flat tire and/or adding wind shield wiper fluid, in a paper instruction manual, such as an owner's manual. However, vehicle manufacturers have been removing paper instruction manuals in favor of electronic instruction manuals. Doing so advantageously reduces vehicle weight, improves packaging (e.g., increases glove box space), saves vehicle owners time, improves the high technology image of vehicle manufactures, and so on.

One challenge with known electronic instruction manuals is that their use is not intuitive. Vehicle owners typically require a basic understanding on how to use the electronic instruction manual and look up information therein. An additional challenge is that such an understanding typically cannot be obtained from a paper instruction manual, since the paper instruction manual is typically replaced with an electronic instruction manual. Accordingly, vehicle owners may be forced to seek out other sources of information, which may prove burdensome.

Accordingly, a need exists for new and improved systems and/or methods which overcome the above-referenced problems and others.

### BRIEF DESCRIPTION

A system for providing a user of a vehicle with interactive vehicle help is provided. The system includes a user input device that allows the user to selectively trigger execution of a vehicle function. The system further includes an output device and at least one more processor. The processor is programmed to receive a user request to enable an interactive vehicle help mode; disable execution of the vehicle function in response to the received user request; and output help information pertaining to the vehicle function to the user via the output device in response to triggering of the user input device.

A method for providing a user of the vehicle with interactive vehicle help is provided. The method includes receiving a user request to enable an interactive vehicle help mode. Execution of a vehicle function is disabled in response to the received user request. Help information pertaining to the vehicle function is output to the user via an output device in response to triggering of the user input device.

A system for providing a user of a vehicle with interactive vehicle help is provided. The system includes a user input device that allows the user to selectively trigger execution of a vehicle function. The system further includes a first control unit responsible for executing the vehicle function, an output device, and a second control unit. The second control unit includes at least one processor. The processor is programmed to receive a user request to enable an interactive vehicle help mode; disable execution of the vehicle function in response to the received user request; and output help information pertaining to the vehicle function to the user via the output device in response to detecting triggering of the user input device.

### BRIEF DESCRIPTION OF THE DRAWINGS

FIG. 1 is a block diagram of a vehicle having an interactive vehicle help mode; and,

FIG. 2 is a block diagram of a method for providing a user of the vehicle with interactive vehicle help.

### DETAILED DESCRIPTION

As described hereafter, a vehicle help mode allows users of a vehicle to electronically obtain help information pertaining to various vehicle functions, such as opening a window. Users enter the vehicle help mode by pressing, for example, a help button suitably located on the center console of the vehicle. Upon entering the vehicle help mode, execution of vehicle functions is disabled. Users then obtain help information, typically via a display device in the center console, by attempting to trigger the execution of vehicle functions for which help information is desired.

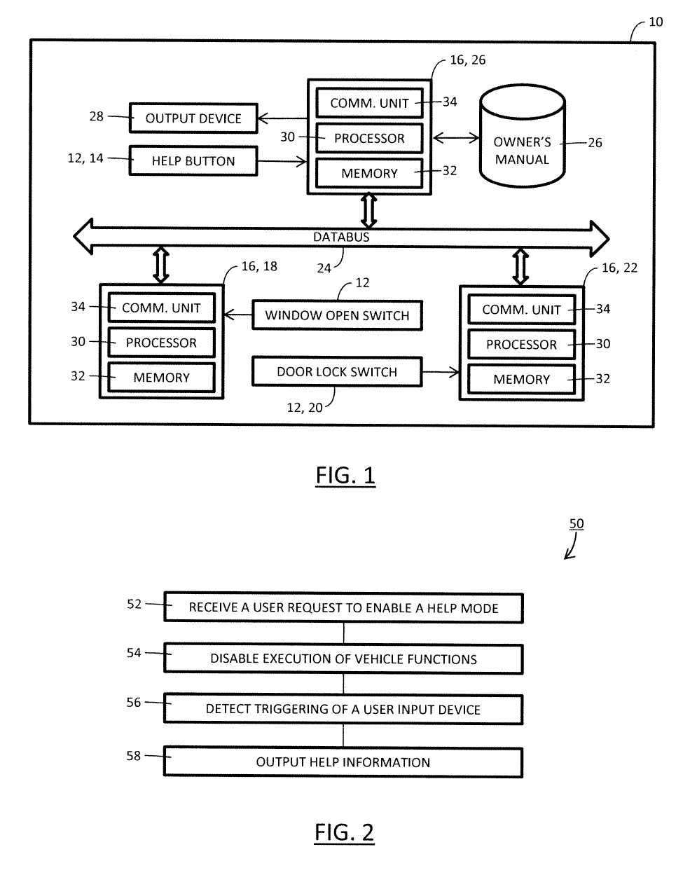

With reference to FIG. 1, a vehicle 10 includes a plurality of user input devices 12, each allowing users, such as drivers and/or passengers, to selectively generate a trigger message and/or signal for a vehicle function. Trigger messages and/or signals indicate user desire to execute corresponding vehicle functions. Vehicle functions include, for example, one or more of enabling and/or disabling a vehicle help mode, opening and/or closing a window, moving a seat backward and/or forward, locking and/or unlocking the vehicle 10, enabling and/or disabling heated seats, setting the heat level of heated seats, enabling and/or disabling windshield wipers, setting the speed of windshield wipers, and so on. As one skilled in the art will appreciate, this list is representative only and not intended to limit the scope of vehicle functions to which the vehicle help mode applies.

The user input devices 12 are typically located throughout the vehicle cabin, such as on instrument panels, door panels, arm rests, the steering wheel, or center consoles, and so on but other locations, such as the exterior of the vehicle 10, are contemplated. Further, the user input devices 12 preferably include a help mode user input device (sometimes referred to as a first user input device) 14 for selectively generating a trigger message and/or signal for enabling the vehicle help mode. Suitably, the help mode user input device 14 is intuitively marked and located within the cabin of the vehicle 10 to allow users of the vehicle to easily see and identify the help mode user input device 14 as enabling a vehicle help mode. For example, the intuitive marking of the help mode user input device 14 in one example is a button marked with a question mark. Likewise, an intuitive convenient location may be in the center console of the vehicle 10, optionally part of a navigation display system and/or an audio system.

Responsibility for executing each of the vehicle functions of the user input devices (sometimes referred to as a second user input device) 12 is assigned to one or more control units 16. For example, responsibility for opening a window is assigned to a first control unit 18. A control unit typically receives the trigger messages and/or signals for its respective vehicle functions directly from the user input devices 12. However, a control unit can receive the trigger messages and/or signals for its respective vehicle functions indirectly via, for example, other control units. For example, the first control unit 18 can receive a trigger message and/or signal from a door lock switch 20 via a second control unit 22. Where trigger messages and/or signals are exchanged between the control units 16, the messages and/or signals are suitably exchanged over a databus and/or communications network 24 (FIG. 1).

In response to the received trigger messages and/or signals, the control units 16 behave differently depending upon whether the vehicle help mode is enabled or disabled. As noted above, the help mode user input device 14 can generate a trigger message and/or signal for enabling the vehicle help mode. In certain embodiments, the vehicle help mode is disabled until the vehicle is in a certain state and/or condition. For example, the vehicle help mode can be disabled until the vehicle is stationary and/or in park. Advantageously, this promotes safety interests.

If a user enables the vehicle help mode, for example by pressing a first user input device or button that has a question mark while the key is still in the vehicle, a user could engage a second user input device such as the power window switch and the navigation screen would display an explanation of power window operation and/or an audible description of power window operation would be provided. A user may not recognize that the power windows have an express “up” or “down” which description could be displayed and/or described. Similar help functions could be available via touch screen icon or by operating one or more other functional devices in the vehicle while the help mode is active, such as power seats, power locks, headlamp operation, entertainment features, moonroof/sunroof operation, etc. this list is intended to be representative only an inclusion of other items or functions in the vehicle help mode could be provided without departing from the scope and intent of the present disclosure.

When the vehicle help mode is disabled, the control units 16 execute the vehicle functions corresponding to received trigger messages and/or signals. Executing a vehicle function includes executing software and/or activating hardware to achieve the vehicle function. For example, executing a vehicle function can include executing a software routine to enable a vehicle help mode. As another example, executing a vehicle function can include activating a relay and/or an electric motor to open a window.

While executing the vehicle function for enabling the vehicle help mode, the control unit responsible for doing so disables execution of other vehicle functions, excluding vehicle functions for disabling the vehicle help mode. As such, when the vehicle help mode is enabled, execution of the other vehicle functions is disabled. Where the control units 16 include a plurality of control units executing the vehicle functions, it is contemplated that the control unit responsible for enabling the vehicle help mode notifies the other control units to disable execution of corresponding vehicle functions. Such notification is suitably provided via the databus and/or communications network 24.

When the vehicle help mode is enabled, the control units 16 collect and provide audio and/or visual information pertaining to the vehicle function corresponding to received trigger messages and/or signals to users of the vehicle 10. For example, upon enabling the help mode and pressing the window open switch 20, audio and/or visual information pertaining to opening the window is provided to the user. Where the control units 16 include a plurality of control units, the control units 16 suitably relay trigger messages and/or signals to a central one of the control units 16, such as the control unit responsible for enabling the vehicle help mode. The central control unit then acts accordingly to collect and provide the audio and/or visual information pertaining to the vehicle functions of the relayed trigger messages and/or signals.

The control units 16 collect the audio and/or visual information from a memory and/or database 26. The audio and/or visual information can include any information relevant to the vehicle functions, but suitably includes information typically found in a paper owner's manual. Further, the control units 16 provide the audio and/or visual information using an output device 28 of the vehicle 10. The output device 28 can include a display device and/or system (e.g., a navigation display system), an audio device and/or system (e.g., speakers associated with a radio system), and so on. When the output device 28 conveys information visually, it is typically is mounted within the cabin of the vehicle 10, such as in the center console, so as to convey information in an easily identifiable manner. However, other locations are contemplated, such as video displays associated with a rear entertainment system.

One skilled in the art will also recognize that if the help mode has been enabled by the user, the system may provide an override feature. For example, if the user has enabled the help mode by actuating the first user input device (or “help” button), the system would disable the window “open” feature if the user attempts to actuate second user input device, i.e., the power window “open” switch, and the navigation system display screen, for example, would display a description of the operation of the power windows. However, the override feature would allow the user to bypass the vehicle function disable feature. Specifically, one manner of overriding the disable feature and enable execution of the vehicle function (power “open” the window) when in the help mode is to continue to actuate, hold, or depress the window “open” switch. In this manner, if an emergency occurs while in the help mode, the user can override the system and still allow the vehicle function to be performed. Likewise, holding the switch will only enable the vehicle function if it is otherwise available. For example, if the user depresses and holds the cruise control “set” button, the user cannot operate or set the cruise control if the vehicle is in “park”.

To carry out the foregoing functionality, the control units 16 include one or more processors 30 programmed to execute computer executable instructions on one or more memories 32. The computer executable instructions suitably embody the foregoing functionality, including the functionality pertaining to the vehicle help mode and/or the software of the vehicle functions. The control units 16 further include one or more communication units 34 facilitating communication amongst the control units 16 and/or between the control units 16 and at least one of the user input devices 12, the output device 28 and the database and/or memory 26.

With reference to FIG. 2, a preferred method 50 for providing a user of the vehicle 10 with interactive vehicle help is provided. The control unit(s) 16 suitably carries out the method 50. According to the method 50, a user request to enable an interactive vehicle help mode is received 52. The user request is suitably a trigger message and/or signal from the help mode user input device 14. In response to the received user request, the execution of vehicle functions, excluding vehicle functions to disable the vehicle help mode, is disabled 54. For example, vehicle functions, such as moving power seats and/or moving windows up and down, are disabled. In addition to disabling the execution vehicle functions, trigger messages and/or signals for vehicle functions are detected 56. In response to detecting triggering of the user input device, help information pertaining to the corresponding vehicle function is output 58 to users of the vehicle via the output device 28.

The intuitive, interactive vehicle help system may also include a “Programming Mode”. Particularly, after accessing the system as described above, the software is configured to walk the user through one or more programming or set-up menus in connection with the associated power switch, button, etc. that is, memory seating, Bluetooth setup, etc. are various features that can then be programmed via the interactive vehicle help menu. Thus, once the user has entered the help mode, an option is provided to go directly into the programming mode in order to program or set up one or more of the various functions.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The disclosure has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A system for providing a user of a vehicle with interactive vehicle help, said system comprising:
a first user input device that allows the user to enable an interactive vehicle help mode;
a second user input device that allows the user to selectively trigger execution of a vehicle function;
an output device; and,
at least one processor programmed to:
disable execution of the vehicle function in response to the received user request in the help mode; and,
output help information pertaining to the vehicle function to the user via the output device in response to triggering of the user input device.

2. The system according to claim 1, further including:
an override feature that allows a user to enable execution of the vehicle function when in the help mode.

3. The system according to claim 1
wherein the processors are further programmed to disable execution of the second vehicle function in response to the received user request.

4. The system according to claim 1, further including:
a control unit intermediate the processors and the user input device, wherein the processors disable execution of the vehicle function via the control unit.

5. The system according to claim 1, further including:
a first control unit responsible for executing the vehicle function; and,
a second control unit including the processors, wherein the disabling includes notifying the first control unit to disable execution of the vehicle function.

6. The system according to claim 1, wherein the user input device is located on an instrument panel, a door panel, arm rest, steering wheel, or a center console.

7. The system according to claim 1, wherein the vehicle function is one of moving a seat, opening a window, and locking doors.

8. The system according to claim 1, wherein the output device includes a display device and/or an audio device.

9. A method for providing a user of the vehicle with interactive vehicle help, said method comprising:
receiving a user request to enable an interactive vehicle help mode;
disabling execution of a vehicle function in response to the received user request;
triggering of the user input device; and,
outputting help information pertaining to the vehicle function to the user via an output device in response to the triggering of the user input device.

10. The method according to claim 9, further including:
notifying one or more control units to disable execution of corresponding vehicle functions, wherein the control units include a control unit responsible for executing the vehicle function.

11. The method according to claim 9, wherein the interactive vehicle help mode is disabled until the vehicle enters a predetermined state.

12. The method according to claim 9, wherein the user request is received from a second user input device that allows a user to selectively generate the user request.

13. The method according to claim 9, wherein the execution of the vehicle function includes disabling via a control unit.

14. The method according to claim 9, further comprising locating the user input device on an instrument panel, a door panel, arm rest, steering wheel, or a center console.

15. The method according to claim 9, further comprising entering a programming mode to set up the user input device.

16. The method according to claim 9, wherein the outputting step includes using a display device and/or an audio device.

17. At least one processor programmed to perform the method according to claim 9.

18. A non-transitory computer readable medium carrying software which controls one or more processors to perform the method according to claim 9.

19. A system for providing a user of a vehicle with interactive vehicle help, said system comprising:
a first user input device that allows the user to selectively trigger execution of a vehicle function;
a first control unit responsible for executing the vehicle function;
an output device; and, a second user input device that allows the user to enable an interactive vehicle HELP mode;
a second control unit having one or more processors programmed to:
disable execution of the vehicle function in response to the received user request via the second user input device; and,
output help information pertaining to the vehicle function to the user via the output device in response to triggering of the user input device.

20. The system according to claim 19, further including:
an override feature that allows a user to enable execution of the vehicle function when in the HELP mode.
